(19) United States
(12) Patent Application Publication
(10) Pub. No.: US 2025/0292700 A1
(43) Pub. Date: Sep. 18, 2025

(54) ASSISTIVE MARKER AND METHOD OF ASSISTING USERS IN THEIR DEVELOPMENT OF FINE MOTOR SKILLS

(71) Applicant: Claudia STOTHART, South Yarra (AU)

(72) Inventor: Claudia STOTHART, South Yarra (AU)

(21) Appl. No.: 19/224,635

(22) Filed: May 30, 2025

Related U.S. Application Data
(63) Continuation of application No. PCT/AU2023/051232, filed on Nov. 30, 2023.

(30) Foreign Application Priority Data
Dec. 1, 2022 (AU) 2022903661

(51) Int. Cl. G09B 11/00

(52) U.S. Cl. CPC G09B 11/00

(57) ABSTRACT

The invention has been developed primarily for assisting young children as users in their development of fine tune skills that can be used for marking, drawing, colouring, and writing skills. Although the invention can also be used in development or redevelopment of skills after serious accidents or strokes. The invention relates to an assistive marker for assisting users in their development of marking skills comprising a body having a size and shape to fit substantially within the natural resting spacing V-section of the user's forefinger and the thumb, wherein the user is able to hold and use the assistive marker in a relatively relaxed pincer grip substantially near the natural resting spacing of the user's forefinger and thumb and a method of using such an assistive marker.

### FIELD OF THE INVENTION

The present invention relates to assistive markers and in particular to a training aid in assisting the development of fine motor skills for undertaking marking and writing.

The invention has been developed primarily for assisting young children as users in their development of fine tune skills that can be used for marking, drawing, colouring, and writing skills. Although the invention can also be used in development or redevelopment of skills after serious accidents or strokes.

It will be described hereinafter with reference to the application to development and correction of skills of young children. It will, however, be appreciated that the invention is not limited to this particular field of use.

### BACKGROUND OF THE INVENTION

Fine motor disability is an inability or impairment of an individual to perform tasks that require a degree of manual dexterity. Fine motor disability is a symptom of an underlying disease process rather than a disease in its own right. To perform even simple fine motor movements requires communication between the premotor and motor cortex, cerebellum, basal ganglia, corticospinal tracts, and peripheral nerves, not to mention visuospatial, sensory, and executive function processing.

Additionally, injuries to musculoskeletal components may also affect fine motor abilities. Fine motor ability is usually synonymous with the literature concerning the ability of an individual to make precise, voluntary, and coordinated movements with their hands.

Despite these examples, the manual dexterity of the hand plays a much larger role in evaluating a fine motor disability. For example, all fine motor development milestones in children relate to the ability of a child to use their hands in more refined and purposeful movements. For example, at 2 months of age, a child may be expected to hold a rattle, and at 12 months, the ability to hold something with a ‘pincer grip’ between 2 fingers on the same hand. This focus on hand dexterity reflects the importance of an individual's hands in performing tasks required in day-to-day life. A defining feature of anthropoids is the ability to perform skillful maneuvers with their hands. It has been postulated in common parlance and the scientific community that pincer ability associated with the opposable thumb garners humans the unique capacity for complex, subtle motor tasks.

Fine motor disability can affect anyone at any age but is especially important during a child's development. Fine motor ability is closely monitored by clinicians as significant delays in recognized milestones can indicate a range of underlying neurological disorders. Fine motor skills have been found to predict social and cognitive ability in pre-kindergarten children independently. This further reflects the linked development of problem-solving to the physical manipulation of the environment and the importance of fine motor skills in social play. Three major components of fine motor control are grip force scaling, speed of movement, and motor coordination.

Owing to the enormous variety and causes of fine motor disability, precise epidemiology remains challenging, and fine motor disability is infrequently independently researched, especially regarding population-based epidemiology. Below are the prevalences of etiologies of fine motor disability; an important caveat is that data may include individuals without a significant fine motor disability, but a condition strongly associated with it.

Estimated developmental disability in children in the US-17.8% comprising:
a. Attention deficit hyperactivity disorder 9.5%,
b. autism spectrum disorder 2.5%,
c. intellectual disability 1.2% and
d. other causes 4.1%.

In adults:
Stroke-2.8% of the US population, 50% of which had a hemiparesis
Rheumatoid arthritis-2% of North America, 30% require assistance for personal care.
Traumatic brain injury-1.1% of the US population, 43% of patients have a lasting disability.
Self-care-3.6% of the US population have a disability.

A number of problems occur with using a writing tool such as a pen or pencil which is elongated (and greater than the depth of the V-section between the forefinger and the thumb) and needs to be controlled in the developed stage in that it needs to be held in a tight controlled pincer movement by the forefinger and the thumb and needs to have the pencil extending on the outside of the hand beyond the V-junction webbing between the thumb and forefinger. This clearly is substantially closing down from the natural spacing to a stressed closed spacing that requires muscle control and balance and coordination. It further needs to undertake the complex coordination of the balance of the tripod of the forefinger, middle finger, and thumb.

As children develop these fine motor skills need to be learned. Some have difficulty progressing through the development stages. Others with disabilities or deformities or recovering from injuries also have difficulties in normal writing skills.

“Fine motor” refers to the group of skills involved in the ability to manipulate smaller objects with the hands and fingers, for example, grasping, holding, and pinching (Victoria State Government, 2022). The Australian Early Years Learning Framework and the Head Start Early Learning Outcomes Framework identify the importance of fine motor development as a foundation for children's independence.

A child's fine motor skills impacts their pen grasp, and therefore, their handwriting proficiency. Handwriting proficiency and drawing progress depends largely on the development of fine motor skills and dexterity throughout early childhood (Huffman and Fortenberry, 2011).

Furthermore, handwriting proficiency has been linked to later academic achievement (Suggate, Pufke & Stoeger, 2018; Dinehart, 2015). Evidence has demonstrated a close relationship between fine motor development and other aspects of language, literacy, and cognitive development (Wang, 2014; Cadoret, 2018; Oberer, Gashaj, Roebers, 2017).

From birth to eight years, children continually acquire, refine, and consolidate their fine motor functions and skills and integrate these skills across life domains (EYLF). Fine motor skills impact children's sense of identity, connection, and contribution to the world, being confident and involved learners and effective communicators (Victoria State Government, 2022). This provides justification for fine motor being an extremely important learning focus for emergent literacy, communication, connection and learning.

Referring to FIG. 1, the development of pen grasp in children typically follows a predictable progression. Pen grasps generally develop from least mature (i.e., radial palmer grasp) to most mature (i.e., lateral or dynamic tripod grasp). In general, children move through four to five stages of pen grasps as they grow and develop: First stage of phase 1 for 1 to 1.5 year olds is a palmar supinate grasp or radial cross palmar grasp 21; Second stage of phase 2 for 2 to 3 year olds is a digital pronate grasp 22; Third stage of phase 3 usually undertaken by 3 to 4 year olds is a modified or static tripod grasp 23; and this leads to Fourth stage of phase four by 5 to 6 year olds of a dynamic tripod grasp 24. Therefore, the development is to move from a coarse control of the palmar control to a fine control of a dynamic tripod grasp.

As children grow and develop strength, stability and dexterity in their shoulders, wrists, hands, and fingers, they naturally progress through each stage. Typically, children without fine motor delays move through the phases in a timely manner without the need for assistance. Others are restricted in their development and generally stay with coarse inferior underdeveloped grips such as shown as grips 31, 32, and 33 of FIGS. 2, 3 and 4.

Children with fine motor delays have pen grasp difficulties and are delayed in moving through each grasp phase. This results in children commencing school whilst still in phases one or two. As mentioned above, this can have a negative impact on children's language, literacy, and cognitive development (Wang, 2014; Cadoret, 2018; Oberer, Gashaj, Roebers, 2017). It can have a negative impact on children's handwriting proficiency, academic achievement, overall confidence, connection to their world, effective communication and more (Suggate, Pufke & Stoeger, 2018; Dinehart, 2015; EYLF). This provides justification for fine motor being an extremely important learning focus.

Research reveals that a large proportion (10% to 24%) of young children experience difficulties performing fine motor skills adequately (Victorian State Government, 2022). Almost one in four children from vulnerable communities in Australia experience fine motor difficulties (Strooband, Rosnay, Okely 2020). Furthermore, it is estimated approximately 60% of a child's school day involves fine motor skills (Caramia, Gill, Ohl & Schelly, 2020). This highlights the importance and need for additional support in children's fine motor skills development.

It can be seen that known prior art writing tools having the problems of: being thin and elongated, requiring hand strength, requiring coordination, requiring balancing of long instrument, tending to encourage wrong use, tending to not encourage development to best use for each development stage, not allowing the same instrument to be used over different development stages, indiscreetness, awkwardness, and the inappropriateness of internal aids and external aids.

The present invention seeks to provide an assistive marker, which will overcome or substantially ameliorate at least one or more of the deficiencies of the prior art or assists in moving the user back into the correct development of writing skills or to at least provide an alternative.

It is to be understood that, if any prior art information is referred to herein, such reference does not constitute an admission that the information forms part of the common general knowledge in the art, in Australia or any other country

### SUMMARY OF THE INVENTION

According to a first aspect of the present invention, there is provided an assistive marker for assisting users in their development of marking skills comprising a body having a size and shape to fit substantially within the natural resting spacing V-section of the user's forefinger and the thumb, wherein the user is able to hold and use the assistive marker in a relatively relaxed pincer grip substantially near the natural resting spacing of the user's forefinger and thumb.

The body has a diametrical size substantially in the range of 80 to 110% of the natural resting spacing of the user's forefinger and thumb.

More preferably the body has a diametrical size substantially in the range of about 90% to 95% of the natural resting spacing of the user's forefinger and thumb.

It can be seen that the invention of an assistive marker provides by the unique size, shape and materials of the markers the benefit of supports the development of a mature and correct pen grasp in children with fine motor delays. Assistive markers of the invention differ from other felt tip pens on the market, because they support children to utilize a functional and correct grasp on the pen.

The mission is to design and produce packs of coloured marker pens that supports the development of functional and mature pen grasp in children with fine motor delays. It is also our mission to work in line with The Early Years Learning Framework for Australia (EYLF), contributing to the following goals: children have a strong sense of identity, children are connected with and contribute to their world, children have a strong sense of wellbeing, children are confident and involved learners, and children are effective communicators.

It can be seen that the invention of assistive markers of the invention, having considered the market analysis and research, have three key unique features: thicker diameter but sized and shaped relative to natural resting spacing of a user's forefinger and thumb, short in length relative to the natural resting spacing v-section of the user's forefinger and the thumb, and in-built foam grip.

Assistive markers of the invention are a specialized marker pen, designed to support children with fine motor delays and resultant pen grasp difficulties to develop a mature and correct grasp. Currently, there are no marker pens on the market that offer both short and thick designs to support children developing the tripod pen grasp. Furthermore, there are no pens or pencils for sale that offer an in-built foam grip.

Indirect competitors include Faber-Castell Jumbo Connector Pens 12 Pack. Although stated as ‘jumbo’ in size, these pens do not offer a thickness in diameter that Assistive markers of the invention do. These pens are, however, full size in length, and therefore, do not offer the short component that supports a mature pen grasp.

Similarly, First Creations Maxi Marker Pens 5 Pack are large and chunky in size, but also do not provide the short element needed to support a mature pen grasp. First Creations Easi-Grip Animal Crayons Pack of 4 offer both short and thick designs, however, these are crayons and do not come designed and manufactured as felt tip pens. A downside of using crayons is that crayons require more strength and effort when colouring or writing, as not enough pressure causes crayons to be faint on paper.

Children with fine motor delays have decreased strength in the fingers and hands and have been found to exert inappropriate amounts of pressure on the writing tool, resulting in unsatisfactory pressure used and faint drawing and writing as a result. As pens use ink, children require less pressure when using pens to create clear and strong-coloured work.

Furthermore, crayons have a thicker nib than pens, resulting in more uncontrolled, inaccurate work. Similarly, Honey Sticks Originals Crayons 12 Pack offer a thick diameter, but are also only available as crayons, not felt-tip pens. Lastly, Abilitations Egg Oh's Pencil Grip 3 Pack and Foam Pencil Grips provide the soft grip for added comfort, supporting children to be more able and motivated to participate in activities involving pen/pencil use (e.g., drawing, colouring, writing), by relieving hand pain, reducing fatigue, and improving comfort. All foam grip products, however, are add-ons to already existing pens or pencils. Assistive markers of the invention are unique as the foam grasp comes built into the pen, thus removing the added factor of consumers needing to remove and place foam grips on pens or pencils each time.

In another form of the invention there is provided a method of assisting users in their development of marking skills including the steps of: providing an assistive marker that fits substantially within the user's natural resting spacing forefinger and the thumb; showing a user gently pince the assistive marker by the forefinger and the thumb only partially away from the user's natural resting spacing forefinger and the thumb; wherein the user is led back onto the development path towards a dynamic tripod grasp.

The assistive marker of the invention provides the benefits of:

The unique size, shape and materials of the markers supports the development of a mature and correct pen grasp in children with fine motor delay.

Assistive markers of the invention differ from other felt tip pens on the market, because they support children to utilize a functional and correct grasp on the pen.

The unique selling point is the targeted and unique design features (shape and materials), which assist in developing pen grasp technique in children.

Designed by a trained and experienced paediatric occupational therapist.

Children using the markers develop improved fine motor skills (finger and hand dexterity and strength). Improved dexterity and strength from utilising correct pen grasp results in improved handwriting, language, literacy, and cognitive development.

Fine motor skills improve children's sense of identity, connection and contribution to the world, being confident and involved learners and effective communicators. The invention is for all individuals, to build strength in the intrinsic muscles in the hand and fingers, resulting in increased strength, endurance and dexterity during all fine motor activities including individuals with fine motor delays, or reduced finger and hand strength, or reduced co-ordination and control, or reduced dexterity. Fine motor activities can include academic skills (writing, colouring, drawing, using scissors), self-care skills (doing up buttons, opening and closing containers, dressing-tying shoelaces, doing up sandals, zips, buttons, belts) eating (using cutlery, opening lunch boxes and food bags) hygiene (cleaning teeth, brushing hair, toileting).

The grip length (available area to hold marker) is 3.5 cm, purposefully designed to be short in length to ensure individuals use a pincer/tripod grasp (mature grasp). This is because individuals are unable to wrap all fingers around my short marker pen in a fisted grasp or place all fingers on the pen in a four-fingered (immature and nonfunctional grasp). Individuals therefore open the index finger and thumb to create web space and use a more mature (tripod grasp). Individuals also develop the pincer grip, essential for all fine motor activities.

The wider thick barrel of my invention supports muscle development for all individuals, particularly individuals with reduced grip strength in their hands and fingers. Individuals are able to grip onto wider pens/pencils better than thin ones for a sustained time, building intrinsic muscles in the hands and fingers and enabling increased strength, endurance, independence and enjoyment when participating in all fine motor activities. The thick barrel reduces the strain in the fingers and hands and reduces fatigue and pain when using. The thicker size also supports development of coordination, as individuals requires less dexterity in the fingers and hands to manipulate the marker, making it easier to control and manoeuvre.

The foam around the middle of my invention provides added comfort for increased endurance and enjoyment (reduced fatigue, strain, and pain).

When using the invention, at no point does the users palm come into contact with the pen, as it does in the prior art. The invention does not have the palm touching, as it has the purpose of only have the distal phalanx and middle phalanx parts of the fingers touching the invention to promote a mature and functional pen grasp, as well as open webspace between the thumb and index finger to build intrinsic muscles of the hand and fingers strength. By having the application of pressure by the user's palm in the prior art, the prior art is not supporting a mature and functional pen grasp or building strength in the hand and fingers, as my invention is. The invention is to support the development of intrinsic muscles in the hands and fingers, not for the purpose of easier application of pressure (as is the prior art).

Other aspects of the invention are also disclosed.

It can be seen that large percentages of children and adults have conditions strongly associated with fine motor delays or disability. The defined invention is a tool invented that supports this population. Furthermore, the defined invention can support children without fine motor or developmental delay and can be used as a tool to support all children to build fine motor skills.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is a diagrammatic view of the usual development phases of users in their development of marking skills;

FIGS. 2, 3 and 4 are diagrammatic examples of problems in marking skills and proposed correction in accordance with an embodiment of the invention for assisting users in their development of marking skills;

FIGS. 5 and 6 are diagrammatic views of the natural resting spacing V-section of the user's forefinger and the thumb relevant to the size and shape of an assistive marker without overextension as required in the use of the assistive marker in accordance with the invention;

FIGS. 7 to 11 are diagrammatic views of assistive markers and use of assistive marker in accordance with a preferred embodiment of the present invention; and

FIG. 12 is a diagrammatic step view of a method of assisting users in their development of marking skills in accordance with a preferred embodiment of the present invention.

### DESCRIPTION OF PREFERRED EMBODIMENTS

It should be noted in the following description that like or the same reference numerals in different embodiments denote the same or similar features.

Referring to the drawings, there is shown for assisting users in their development of marking skills.

Muscle development in children can be at differing rates. Children with fine motor delays have reduced strength in their fingers and hands. Children with reduced strength can grip onto wider objects better than thin ones. Children require less strength and coordination to hold a thicker frame.

Coordination is another skill that has a development at widely differing rates. Children with fine motor delays have reduced dexterity and coordination in their fingers and hands. Thicker sized writing tools are easier to coordinate, as children require less dexterity in their fingers and hands to manipulate the writing tool.

Reducing pain or stress in children in any development is important for self-esteem and for positive growth. Children with reduced strength are able to grip onto wider objects better than thin ones for a sustained time, resulting in less fatigue, pain and stress in the fingers and hands. This is hugely important in making writing, drawing, and colouring activities more enjoyable for children with fine motor delays, who may already find these activities challenging.

Development of approach to writing is as described in the phases and as shown by FIG. 1. It is important, however, to provide assistance, or correction if a child is stalled on the development or has deviated away to a form that is not going to help development.

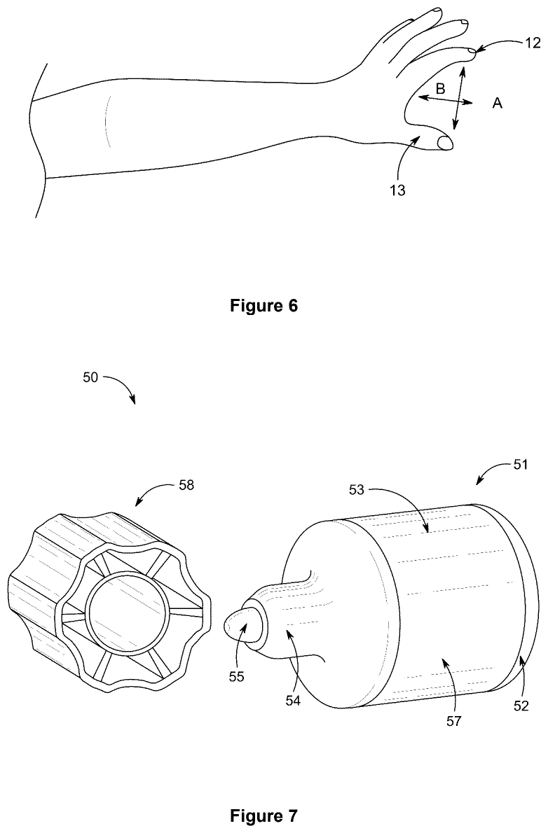

As shown in FIGS. 5 and 6 there is the differences of hands of an adult and a child. The hand of an adult who has developed motor skills as shown in FIG. 5 can be seen to be more elongated and easily able to fold the third fourth and fifth fingers (middle finger, ring finger, and little finger).

In order to enable an easier developmental diametrical size relative to the natural resting spacing of a user's forefinger and thumb allowing the user to readily hold the assistive marker without substantially closing the forefinger and thumb.

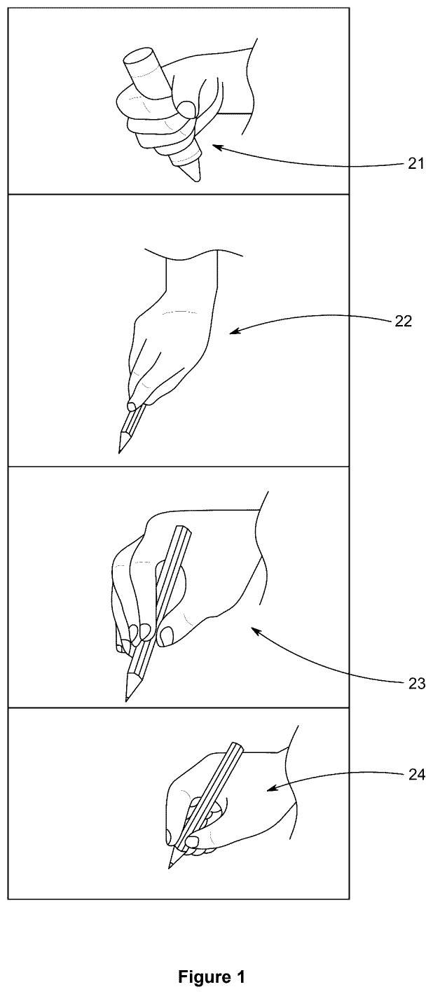

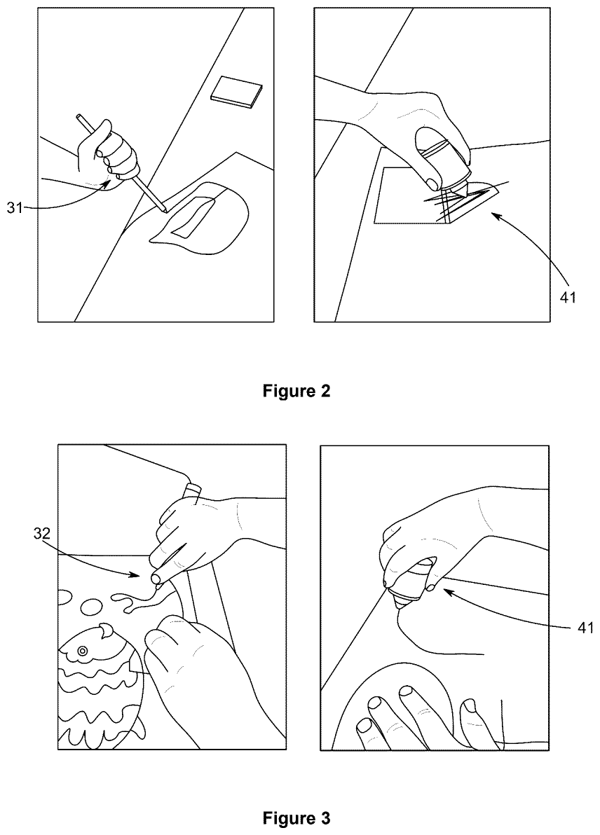

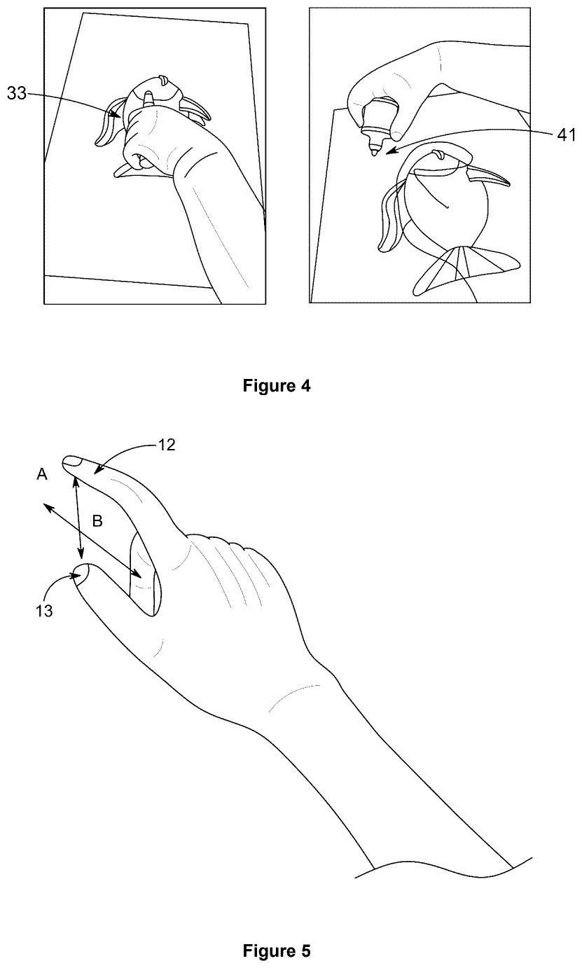

As shown in FIGS. 2, 3, and 4, the faults in development of 31, 32, and 33 which are versions of the palmar supinate grasp 21 and therefore limiting dexterity and proper writing or marking skills. Therefore, the invention provides a method of assisting users in their development of marking skills including the steps of providing an assistive marker that fits substantially within the user's natural resting spacing forefinger and the thumb; and showing a user gently pince the assistive marker by the forefinger and the thumb only partially away from the user's natural resting spacing forefinger and the thumb; wherein the user is led back onto the development path towards a dynamic tripod grasp by moving back to the two finger pincer movement 41 and on the road to the dynamic tripod grasp 24.

It is important therefore that all pre-schoolers and kindergarten aged children should use fat writing tools relative to their natural resting spacing of a user's forefinger and thumb no matter if they have a fine motor delay or not. Thick pens suit the level of muscle development in children in this age bracket better than thin pens.

Short writing/drawing tools promotes children to utilize a pincer or tripod grasp. This is because a child is unable to wrap all fingers around a short apparatus to utilize a fisted grasp. Children therefore open the index finger and thumb to create web space and promote a more mature grasp. Exemplar illustrations herein shows a short crayon opening web space of hand and promoting a tripod grasp.

Short writing tools build intrinsic muscles in the hands and fingers, allowing for increased strength and endurance in writing and colouring tasks.

Short writing tools are manipulated more easily in the hand. This discourages children from using too many fingers and putting too much force on the writing tool.

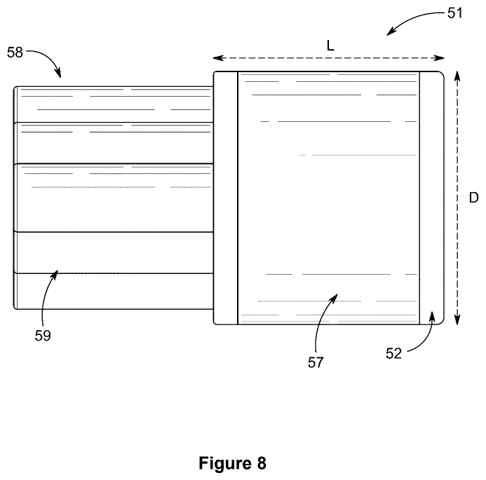

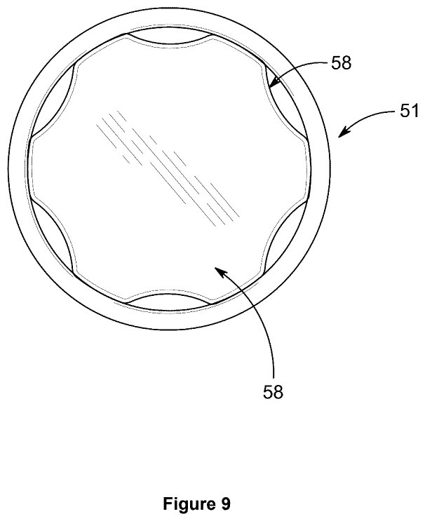

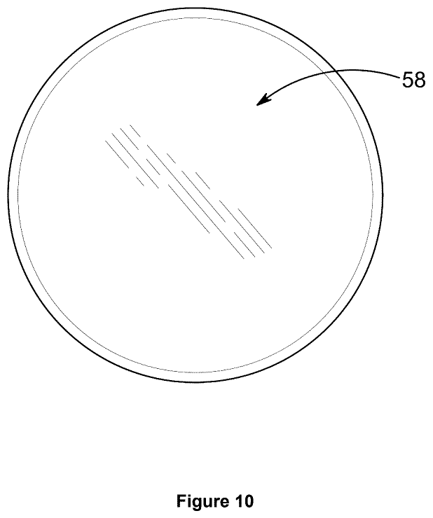

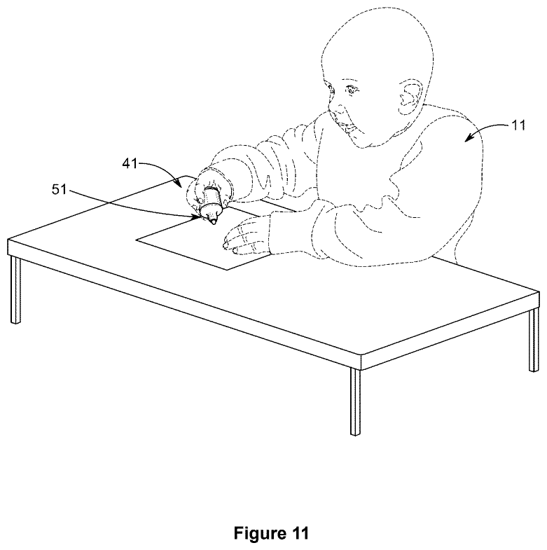

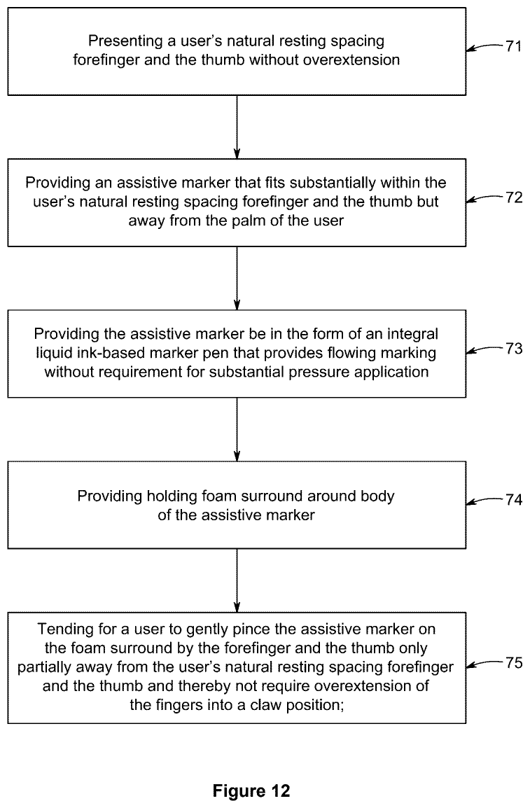

Referring to FIGS. 7 to 10, there are diagrammatic views of an assistive markers in accordance with various preferred embodiments of the present invention. The assistive marker can include the body having a central holding part 53 having a diametrical size relative to the natural resting spacing of a user's forefinger 12 and thumb 13 allowing the user to readily hold the assistive marker without substantially closing the forefinger and thumb. The body can further include a rear part sized such that the central holding part and rear part fit substantially within the V-section of the user's forefinger and the thumb but spaced from the palm of the user to avoid driving of the pen by the palm. A front part 54 can include a marking end 55 protruding beyond the end a distance no greater than the diametrical size of the central holding part 53 that can be covered by foam 57 to enhance a soft fine motor grip.

The central holding part is preferably the maximum width of the diametrical size substantially in the range of 90 to 95% of the natural resting spacing of the user's forefinger and thumb.

The rear part in various embodiments can include a shape or dimension so as to have a decreasing diametrical size to more readily fit in the depths of V-section of the user's forefinger and the thumb. Importantly, however, the length of the assistive marker is such that it remains spaced from the palm of the user so as to not revert back to a claw hold with pressure applied by the palm. Instead, the spacing ensures the development of the pincer hold. The end can have a curved bottom to more readily fit in the depths of V-section of the user's forefinger and the thumb while it can have a smaller diametrical dimension of the rear part compared to the central holding part.

### Example 1

In FIGS. 2, 3, and 4, there are a series of before and after illustrations of children using an embodiment of an assistive markers of the invention. The illustrations show the hugely positive impact assistive markers of the invention have on supporting a correct grasp. Opening the web space to support a mature pincer grasp. The hands of the children photographed are all children supported by a paediatric occupational therapist, and with all the children initially exhibiting delayed pen grasp due to fine motor delays.

### Example 2

In the embodiment of FIGS. 7 to 11, the assistive marker 50 has a body 51 and a detachable lid 58.

The body is a substantially cylindrical body 51 that has a central holding part 53 with a foam 57 extending around the circumference and forming the holding position for the user to hold in a substantially pincer form. This allows the body 51 of the assistive marker 50 to be used for assisting users in their development of marking and fine motor skills.

The body 51 has a size and shape substantially matching the natural resting spacing of the V-section of the user's forefinger and the thumb, identified A and B as shown in FIGS. 5 and 6. It is also sized in length so that in use it is spaced from the palm of the user. Thereby instead of a claw grip, the user is able to hold and use the assistive marker in a relatively relaxed pincer/tripod grip substantially within the natural resting spacing of the user's forefinger and thumb.

It can be seen that the assistive marker according to this embodiment is substantially cylindrical. This means that there is not one orientation of using the assistive marker. Further as the front of the marker has a symmetrical central throat 54 with a central protruding marker nib 55 extending therefrom, then holding the cylinder in any orientation along its longitudinal axis but in any rotational configuration does not alter its use. Therefore, it is readily usable by a user developing their skills.

As stated, the body 51 has a relative diametrical size and constant cross-sectional shape to the natural resting spacing of the V-section of the user's forefinger and the thumb to avoid overextension of the fingers of the user into a claw like hold but instead to encourage a relatively relaxed pincer/tripod grip. Preferably the body has a relative diametrical size substantially in the range of 80 to 110% to the natural resting spacing of the user's forefinger and thumb. In one form, however, the body has a diametrical size substantially in the range of about 90% to 95% to the natural resting spacing of the user's forefinger and thumb.

This relative sizing and shaping and lack of overextension means the user does not need to immediately know how to control and apply directed pressures along the fingers and through controlled forced bending of the fingers to exert pressure to bend the fingers at the finger joints and particularly not at the joint closest to the fingertip being the distal interphalangeal joint (the DIP joint). Usually when users find they cannot achieve this controlled forceful position they instead revert back to a sideways grasp such as the palmar supinate grasp or radial cross palmar grasp 21 shown in FIG. 1.

In an embodiment for use by a young child, the assistive marker can have the cylindrical body with a diameter in the range of 25 to 35 millimetres. Further the cylindrical body can have a length in the range of 30 to 40 millimetres.

The outer holding surface includes a resilient material 57 of a ring of foam around the circumference of the substantially cylindrical body aiding a soft hold of the assistive marker.

The body 51 integrally includes a marking liquid reservoir and connects to a protruding nib or stylus 55. The nib or stylus 55 is a wicking nib connected to the marking liquid reservoir in the central holding part 53 for wicking therefrom. In particular the marker is an integral liquid ink-based marker pen.

The lid 58 has a diameter smaller than the body of the assistive marker so that an infant's hand can readily grasp the lid. The outer side of the lid includes fluting around the circumference of the lid and the fluting is consistently spaced to enhance grippability.

### In Use

The user starts with an understanding of a correct holding position by, in Step 71, presenting a user's natural resting spacing forefinger and the thumb without overextension.

In Step 72 there is provided an assistive marker that fits substantially within the user's natural resting spacing forefinger and the thumb but away from the palm of the user.

As shown in Step 73 it is important to not require resistive force at the start such as occurs with use of pencils or chalks or crayons which require enough force to tear off some material and leave it on the page. Instead in this step there is provided the assistive marker be in the form of an integral liquid ink-based marker pen that provides flowing marking without requirement for substantial pressure application.

In Step 74 the assistive marker is provided with a holding foam surround around body of the assistive marker which again assists the user and minimizes forces needed. Directive greater forces are fine motor skills that are being developed but along a training pathway that results in effective learning by the apparatus, relative shaping and dimensions and leading features that tend the user to the correct development.

Step 75 is tending for a user to gently pince the assistive marker on the foam surround by the forefinger and the thumb only partially away from the user's natural resting spacing forefinger and the thumb and thereby not require overextension of the fingers into a claw position.

It should be noted that the assistive marker is sized and shaped to start and progress the development of the user's fine motor skills a relatively relaxed pincer/tripod grip 41 substantially within the natural resting spacing of the user's forefinger and thumb by the user gently pincing the assistive marker by the forefinger and the thumb only partially away from the user's natural resting spacing forefinger and the thumb and thereby not require overextension of the fingers into a claw position. As the user develops and possibly grows, however, it is not necessary for the assistive marker to be similarly grown in shape or size. Instead, the user's skills develop and can maintain the fine motor skills needed to control a smaller diameter marker or pen. The important element is that the starting point of the training position is making use of the correct handling and not forcing a user without the skills to start with an incorrect training position.

### Advantages

### Cylindrical Shape

The body is preferably a cylindrical shape or consistent symmetrical cross section. By cylindrical it does not have to be perfectly round instead it can be polygonal to the extent that it is not a four-sided polygon which results in sharp corners but is sufficiently multisided polygon that there is a symmetry and a near cylindrical shape without sharp corners that allows the user to use in any orientation. The cylindrical shape could be circular but have shallow fluting strips extending parallel to the longitudinal axis so again there is a symmetry and a near cylindrical shape without sharp corners that allows the user to use in any orientation.

If the assistive marker is not cylindrical or substantially cylindrical then the user is not able to pick up the assistive marker and immediately be in an acceptable position for the intended training.

One example that does not fulfil the benefit of the invention is if there is a frustoconical shape which narrows as it extends away from the palm of the user. This causes the user to need to exert further forces and extra finger extension and pressure. It also requires further contact of the palm of the user to push the back of the device. Therefore, again it does not allow training of fine motor skills.

Another example that does not fulfil the benefit of the invention is if there is an enlarged body which narrows to a neck portion away from the palm of the user and requiring the user's fingers to extend around the body and hold the pen at the neck. This requires the user to exert further forces and extra finger extension and pressure. Generally, this will result in the user believing a first hold is easier. This does not allow training to a pincer movement.

### Diameter Relative to Users

If the diameter is small like a crayon or pencil, the training and strength training elements of the invention are not achieved. Instead, users are led towards an incorrect position since they are able to wrap their hands/fingers around in a palmer supinate (fisted) grasp, which does not promote a tripod grasp.

Further the prior art can have a tubular gripping member with a cylindrical exterior surface. This tubular gripping member has a diameter. The diameter is, however, usually about 2.00 inches which is approx. 5 cms. This prior art is not aimed at the problem of the present invention and does not provide the solution of the present invention. It has a large size which requires less movement of the fingers when moving and therefore does not support development of strength or dexterity. It instead stagnates development by tending the user to remain in a clasp position.

The present invention has a much different diameter of about 3.2 cm. (32 mm). The different diameter and its relativity to the the natural resting spacing of the V-section of the user's forefinger and the thumb to avoid overextension of the fingers of the user results in a completely different function.

The wider thick barrel of the invention supports muscle development for all individuals, particularly individuals with reduced grip strength in their hands and fingers. Individuals are able to grip onto wider pens/pencils better than thin ones for a sustained time, building intrinsic muscles in the hands and fingers and enabling increased strength, endurance, independence and enjoyment when participating in all fine motor activities. The thick barrel reduces the strain in the fingers and hands and reduces fatigue and pain when using. The thicker size also supports development of coordination, as individuals requires less dexterity in the fingers and hands to manipulate the marker, making it easier to control and manoeuvre.

### Foam Surround

The foam grip on the invention is for the purpose of providing added comfort, supporting users to be more able and motivated to use by relieving hand and finger pain, reducing fatigue, and improving comfort.

### Avoiding Overextension

A substantial advantage that occurs primarily due to due to the feature of the present invention is the ease with which the user can hold the assistive marker in a correct training position.

To achieve this aim the body has a relative diametrical size and constant cross-sectional shape to the natural resting spacing of the V-section of the user's forefinger and the thumb to avoid overextension of the fingers of the user into a claw like hold but instead to encourage a relatively relaxed pincer/tripod grip. This is when the body of the assistive marker has a diametrical size substantially in the range of 80 to 110% of the natural resting spacing of the user's forefinger and thumb and preferably with a diametrical size substantially in the range of about 90% to 95% of the natural resting spacing of the user's forefinger and thumb.

When the body is in this range the fingers and thumb forming the two or tripod hold of the assistive markers are in a natural position. This natural position is when it is not required to exert pressure to bend the fingers at the finger joints and particularly not at the joint closest to the fingertip being the distal interphalangeal joint (the DIP joint). This means there is minimal requirement for pressure and a training point for learning fine motor skills.

### Length Relative to Users

Working in harmony with the thickness of my invention is the length. The small size of the invention promotes a mature grasp. When an assistive marker has a cylindrical body with a diameter in the range of 25 to 35 millimetres, and the cylindrical body has a length in the range of 30 to 40 millimetres it encourages the user to tend towards a pincer/tripod grasp (mature grasp) by being short in length.

This is because individuals are unable to wrap all fingers around the short marker pen in a fisted grasp or place all fingers on the pen in a four-fingered (immature and nonfunctional grasp). Individuals therefore open the index finger and thumb to create web space and use a more mature (tripod grasp). Individuals also develop the pincer grip, essential for all fine motor activities.

Some pen holders have a length such that the end area facing in the opposite direction to the end face is for application of pressure by the user's palm at the base of the user's index finger. By having the application of pressure by the user's palm in the prior art, the prior art is not supporting a mature and functional pen grasp or building strength in the hand and fingers.

Instead, what is required is that the user's palm does not come into contact with the pen. It has the purpose of only have the distal phalanx and middle phalanx parts of the fingers touching the assistive marker to promote a mature and functional pen grasp, as well as open webspace between the thumb and index finger to build intrinsic muscles of the hand and fingers strength.

### Marker

In a preferable form the assistive marker is a liquid ink-based marker pen. It is the pen itself. It is not a crayon or a holder of a crayon.

This is important as a crayon is considered difficult when using as they break, are not accurate (thick tip) and require increased hand and finger strength to achieve results, often resulting in light touch and unsatisfying results.

The invention is not a grip system or tool to house an instrument (crayon, pen, pencil). The crayon has a length. The length is about 2.75 inches (approx. 7 cm). The crayon is fabricated of a waxy writing material.

The invention is not a crayon or related to in any regard crayons. Crayons are considered difficult when using as they break, are not accurate (thick tip) and require increased hand and finger strength to achieve results, often resulting in light touch and unsatisfying results.

Thus, the invention is an ink-based marker pen, as to not have any of these difficulties. Marker pens allow for accurate and controlled lines, fluid motion and obvious results (not light/unclear). Marker pens are particularly supportive of users who have reduced hand and finger strength and provide satisfying results with less strength required.

### Lid

When undertaking an assistive marker to help a user develop their fine motor skills, it is important that all elements are suited to the users. Therefore, the lid must be grippable from any location. It does not have to be orientated before removal. Further there must not be small or complex shapes that would require fine motor skills to remove before the assistive marker has helped to develop the user's fine motor skills.

In an embodiment the lid has a diameter smaller that the body of the assistive marker so that an infant's hand can readily grasp the lid. Further the outer side can include fluting around the circumference of the lid and be consistently spaced to enhance grippability.

### Understanding the Invention

A-Technical Fine Motor Skill Fundamentals that Sunny Markers Aid:

Fine motor fundamentals start with the arches of the hand and open webspace. Our hand muscles help to firm the arches of our hand: longitudinal, traverse and oblique. These arches work together to build the natural curvature of our hand (structure) but also allows mobility (dexterity). They help us with opening up the webspace of our hand and provide a foundation for other fine motor skills (including in-hand manipulation and thumb opposition).

We need strong palmar arches for so many everyday activities such as opening and closing bottles, cupping our hands to roll a dice, playing ball games and more.

An important piece of an open thumb space is the components that make up the skill. These include arch development, opposition of the thumb to the pointer finger, rotation of the thumb CMC joint and flexion of the MCP and IP joints. Thumb webspace mobility in functional tasks which includes opposition with rotation of the thumb at the CMC joint and Flexion of the distal joints of the thumb (MCP joint and IP joint).

The Thener Space/Open Thumb Web Space plays a major role in fine motor skills. There are many anatomical features that impact this motor skills including:
i.—Thenar eminence
ii.—Thenar muscles
iii.—Carpal bones
iv.—Metacarpal bones
v.—Phalangeal bones
vi.—Lumbricals
vii.—Intrinsic muscles
viii.—Median nerve
ix.—Long flexor tendons
x.—Extrinsic muscles
xi.—Long flexor muscles
xii.—Long extensor muscles

Webspace Issues occurs with closed webspace and is when the thumb is pressed/squashed against the side of the index finger during functional tasks. When children write, colour or draw and the webspace area is shut, it is a sign of problems. There may be limited dexterity and precision in fine motor tasks when a closed webspace is present. As a result of a closed webspace, there might be compensating for thumb instability, underdeveloped hand arches, and/or poor strength. Each of these problem areas will lead to difficulties when handwriting, dexterity, manipulation of small items such as beads, and pencil grasp.

Writing with a closed webspace is inefficient and will cause poor and slow handwriting, especially as kids grow and are expected to write at faster speeds. A closed web space while attempting to manage fasteners such as buttons and zippers will lead to fumbling and difficulty.

The devices of the invention have been proven to:
Open the webspace.
Build arch strength across all three arches of the hand (working together).

### B-Fine Motor Fundamentals: Finger Dexterity & Finger Isolation

Finger dexterity refers to the ability to use coordination and manipulation of objects in the hands with precision. Dexterous motor skills can be broken down into areas: grasp and release, coordination within the hand (in-hand manipulation), and proprioception (knowing who much effort is needed to manipulate objects without dropping them).

Together, these precision skills enable us to pick up an object with the right amount of pressure and motor dexterity so you can grasp the object accurately taking eye-hand skills into consideration.

Finger and thumb opposition has a developmental progression leading to pincer grasp, tripod grasp, graded grasp/release, and other precision skills.

Finger Dexterity Issues occur with the inability or impairment to perform tasks that require a degree of manual dexterity, inability to make precise, voluntary, and coordinated movements with their hands.

The fine motor skill of finger isolation is the development of being able to “isolate” or individually use each finger of the hand. Issues with finger isolation result in difficulties counting one finger at a time, tying shoes, typing on a screen or computer keyboard, handwriting and more.

The devices of the invention have been proven to:
Improve a person's ability to build dexterity and isolate individual's fingers in order to perform tasks.

### C-Fine Motor Fundamentals: Pincer Grasp and Neat Pincer Grasp

A pincer grasp is required to pick up small items such as cereal between the pads of the thumb and pointer finger. The pads of the fingers stabilize the small object. This grasp develops around 9-12 months.

Neat pincer grasp uses the tips of the thumb and pointer finger to stabilise objects. Neat pincer grasp develops between 12-18 months and is a much finer skill.

Pincer Grasp and Neat Pincer Grasp Issues are a sign of delayed development, developmental coordination disorder, arthritis, injury, or other undying condition. There is difficulty picking items up, holding, grasping, releasing. This can result in difficulty caring for self (drinking, eating, dressing, bathing), difficulty communicating+expressing self (writing, drawing), difficulty learning (exploring/touching items in environment) and more.

The devices of the invention have been proven to:
Enable user to develop a strong pincer and neat pincer grasp.

### D-Fine Motor Fundamentals: Separation of the Sides of the Hand

Separation of the two sides of the hands, also known as motoring hand separation, is a crucial fine motor skill that enables individuals to perform various daily activities with precision and dexterity. This skill involves dividing the hand into two sides: the “power side” (ulnar side), consisting of the “pinky” and ring fingers, and the “precision side” (radial side), comprising the thumb, index, and middle fingers.

The power side provides stability, while the precision side facilitates manipulation and control. Developing the separation is essential for tasks like writing, using scissors, and manipulating small objects. Separation of the Sides of Hand Issues can be seen when separation of the hand begins to develop as early as infancy. Separation of the hand becomes more refined as children grow and develop.

Poor separation of the hand can affect a child's ability to perform activities expected for their age. —It can affect how an individual holds a writing utensil, as they may present with a gross or fisted grasp on their pencil. In return, the individual will resort to moving their whole arm to write versus utilizing smooth controlled dynamic movements of the pencil with the radial side of their hand. Their writing may appear large and with poor legibility.

An individual with poor separation of their hand may also have difficulty utilizing other functional tools, such as scissors. Cutting skills will be gross and uncoordinated. Self-care tasks such as manipulating fasteners and tying shoes are impacted as well.

The devices of the invention have been proven to:
Enables the user to develop both the power side and precision side of the hand to build strength, precision, control and independence.

### E-Fine Motor Fundamentals: Wrist Extension & Stability

Wrist extension and stability are crucial for various daily activities, including grasping and manipulating objects. Wrist extension refers to the movement of the wrist bending backward, while stability ensures the wrist remains in a neutral position, allowing fingers to move freely.—When you hold your wrist in a slightly extended position, the muscles operating the fingers can pull the tendons (and therefore the finger bones) more easily, which results in better control of the fingers for handwriting.

Wrist Extension and Stability Issues:—Issues with wrist extension and stability can cause individuals to ‘hook’ their wrists, or have flat wrists when they write. This position can cause fatigue and pain in the fingers, hands, wrists, forearm and upper arm. Issues can be because of poor fine motor skills, low muscle town, poor shoulder girdle stability.

The devices of the invention have been proven to:
Allow the user to manipulate in the hand more easily, resulting in wrist extension and stability for more control.

### F-Fine Motor Fundamentals: In-Hand Manipulation

In-hand manipulation (IHM) refers to the ability to move objects within one hand without the assistance of the other hand, a critical component of fine motor skills. This ability enables a range of everyday tasks, such as rotating a pencil, flipping a coin, or adjusting a button, which are essential for daily living and academic activities. In-hand manipulation involves manipulating an object within one hand. The fingers and thumb are used to best position the object for the activity. For example, picking up a pen and moving it into position with your fingers for writing.

In-hand manipulation is a skill requiring strength in the hands.

In-Hand Manipulation Issues for children and adults with disabilities, often presents significant challenges due to the interplay between cognitive impairments and motor deficits. Hand function plays a vital role in accomplishment of all Activities of Daily Living (ADL) and it depends upon a complex interaction of visual-perception and fine motor function which together known as visual perceptual fine motor function. These individuals may experience delays or difficulties in developing the fine motor control necessary for effective In-hand manipulation, impacting their ability to perform basic self-care tasks, work, engage in play, or participate in tasks and activities.

The development of In-hand manipulation is often hindered by reduced muscle tone, coordination issues, and slower cognitive processing. As a result, these individuals may struggle with tasks that others can perform with ease, leading to further delays in their overall development and independence.

The devices of the invention have been proven to:
Improve translation, shift and rotation to improve in-hand manipulation. The devices of the invention build muscle endurance and strength, resulting in improved ability at:
   a. Drawing
   b. Handwriting,
   c. Cutting with Scissors,
   d. Eating with a fork, knife, and spoon,
   e. Dressing skills such as buttons, zippers, and snaps,
   f. Manipulating small objects for crafts and games.

### G-Sensory Input:

Research shows the power of using sensory strategies for enhancing handwriting skills. For children and adults of all ages and abilities, sensory input can enhance fine motor and handwriting skills. Handwriting can be facilitated through the use of sensory strategies to aid in engagement and retention. Our senses include: tactile (feel), auditory (hear), olfactory (smell), gustatory (taste), proprioceptive (body awareness), vestibular (movement), and visual strategies. The devices of the invention textured grip around the barrel of the marker provides tactile feedback to the user which improves grip and control. It also enhances comfort, improves finger placement and addresses sensory needs for better handwriting.

It can be seen that the invention approaches a serious problem and is successful in providing a novel and inventive solution.

### Interpretation

### EMBODIMENTS

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Description of Preferred Embodiments are hereby expressly incorporated into this Description of Preferred Embodiments, with

each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

JAs used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. It is, however, understood that embodiments of the invention may be practiced without these specific details. In other instances, well-known methods, structures, and techniques have not been shown in detail in order not to obscure an understanding of this description.

### Terminology

In describing the preferred embodiment of the invention illustrated in the drawings, specific terminology will be resorted to for the sake of clarity. The invention is, however, not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

“Marking” is to be understood throughout this document to refer to making a mark on a surface and incorporates the actions of writing, drawing, colouring in, and signing etc.

“Writing tools” is to be understood throughout this document to refer to ‘writing tools’ is used to describe any apparatus that may be used for the purposes of drawing, colouring, or writing. Including but not limited to pens, pencils, crayons, chalk, markers.

Writing tools can be understood to include two main categories of implements that allow making a mark on a display surface and results in the actions of writing, drawing, colouring in, and signing etc. The first category will be identified as “marker pens” and will include implements that have a flow of marking liquid expelled onto the display surface upon the nib contacting the display surface. This includes markers pens, permanent markers and highlighters and ball point pens and roller pens. The second category will be identified as “resistive markers” and will include implements that have a residue of material on the display surface upon contacting the display surface and resistively dragged over the display surface. Therefore, the resistive markers category includes pencils and crayons and gouache.

“A normal writing position” is to hold the writing tool balanced on the lower side of the middle finger with the ends of the forefinger and thumbpad on either side such that the coordination of the three digital contacts gives you full precise control. In undertaking marking there is a need to develop the user's fine motor skills in order to handle a marker correctly.

A “natural resting spacing of a user's forefinger and thumb” is to be understood to be a distance that a user naturally has between the forefinger and the thumb without trying to close or pince between the two and without trying to distance or increase spacing between the two. Therefore, in a relaxed position there is a natural spacing between the two. With adults there is a more defined lengthy and strength and the natural resting spacing as shown by dimensions A between the ends of the fingers is about 5 centimetres for a large hand. As shown in a less developed child's hand of FIG. 5 a two-year-old could have a natural spacing A of about 2.5 centimetres. The depth of the V-section between the forefinger and the thumb as shown as B in FIG. 5 for an adult is about 7.5 centimetres for a large hand. As shown in a less developed child's hand of FIG. 6 a two-year-old could have a depth of the V-section between the forefinger and the thumb as shown as B in FIG. 6 of about 3 centimetres.

### Comprising and Including

In the claims which follow and in the preceding description of the invention, except where the context requires otherwise due to express language or necessary implication, the word “comprise” or variations such as “comprises” or “comprising” are used in an inclusive sense, i.e., to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the early learning and educational industries for assisting users in their development of marking or writing skills.

What is claimed is:

1. An assistive marker for assisting users in their development of marking skills comprising:
a body having a size and shape substantially matching the natural resting spacing of the V-section of the user's forefinger and the thumb; and
an outer holding surface surrounding the body,
wherein the assistive marker is sized and shaped with a thicker diameter and shorter in length than usual marker so as to fit substantially within the natural resting spacing of the V-section of the user's forefinger and the thumb and to be spaced from the palm of the user, and
wherein the user is able to hold and use the assistive marker in a relatively relaxed pincer/tripod grip substantially within the natural resting spacing of the user's forefinger and thumb.

2. An assistive marker according to claim 1 wherein the body is substantially cylindrical has a relative diametrical size and constant cross-sectional shape to the natural resting spacing of the V-section of the user's forefinger and the thumb to avoid overextension of the fingers of the user into a claw like hold but instead to encourage a relatively relaxed pincer/tripod grip.

3. An assistive marker according to claim 2, wherein the body has a diametrical size substantially in the range of 80 to 110% of the natural resting spacing of the user's forefinger and thumb.

4. An assistive marker according to claim 3 wherein the cylindrical body has a diameter in the range of 25 to 35 millimetres and a length in the range of 30 to 40 millimetres.

5. An assistive marker according to claim 4 wherein the outer holding surface includes a resilient material aiding a soft hold of the assistive marker.

6. An assistive marker according to claim 5, wherein the body has a diametrical size substantially in the range of 80 to 110% of the natural resting spacing of the user's forefinger and thumb.

7. An assistive marker according to claim 1 wherein the body has a diametrical size substantially in the range of about 90% to 95% of the natural resting spacing of the user's forefinger and thumb.

8. An assistive marker according to claim 1 wherein the body integrally includes a marking liquid reservoir and connects to a protruding nib or stylus wherein the nib or stylus is a wicking nib connected to the marking liquid reservoir for wicking therefrom.

9. An assistive marker according to claim 1 wherein the marker is an integral liquid ink-based marker pen having a flow of marking liquid expelled onto the display surface upon the nib or stylus contacting the display surface.

10. An assistive marker according to claim 1 has a lid with a diameter smaller that the body of the assistive marker so that an infant's hand can readily grasp the lid.

11. An assistive marker according to claim 10 wherein the outer side of the lid includes fluting around the circumference of the lid and the fluting is consistently spaced to enhance grippability.

12. An assistive marker for use by a child without adult assistance for assisting users in their development of marking skills comprising:
an integral marker body having a marker reservoir leading to a marking end;
a size and shape substantially matching the natural resting spacing of the V-section of the user's forefinger and the thumb;
an outer holding surface surrounding the body; and
a lid for closing over the marking end,
wherein the assistive marker is sized and shaped with a thicker diameter and shorter in length so as to fit substantially within the natural resting spacing of the V-section of the user's forefinger and the thumb and to be spaced from the palm of the user,
and wherein the user is able to hold and use the assistive marker in a relatively forefinger and thumb,
and wherein the body has
a central holding part having a diametrical size relative to the natural resting spacing of a user's forefinger and thumb allowing the user to readily hold the assistive marker without substantially closing the forefinger and thumb,
a rear part sized such that the central holding part and rear part fit substantially within the V-section of the user's forefinger and the thumb, and
a front part including a marking end and protruding beyond the end a distance no greater than the diametrical size of the central holding part
and further wherein the lid is readily removable by having a diameter smaller than the body of the assistive marker so that an infant's hand can readily grasp the lid and including fluting around the circumference of the lid and the fluting is consistently spaced to enhance grippability
wherein the assistive marker is able to be readily:
selected by the child,
opened by the child, and
used by the child.

13. An assistive marker according to claim 12 wherein the central holding part is the maximum width of the diametrical size substantially in the range of 90 to 95% of the natural resting spacing of the user's forefinger and thumb.

14. An assistive marker according to claim 12 wherein the rear part has a decreasing diametrical size to more readily fit in the depths of V-section of the user's forefinger and the thumb.

15. An assistive marker according to claim 12 wherein the rear part has a curved bottom to more readily fit in the depths of V-section of the user's forefinger and the thumb.

16. An assistive marker according to claim 12 wherein the body includes a gripping surface on the body at the diametrical location that the user holds the marker.

17. A method of assisting users in their development of marking skills including the steps of:
providing an assistive marker that fits substantially within the user's natural resting spacing forefinger and the thumb but away from the palm of the user;
providing the assistive marker be in the form of an integral liquid ink-based marker pen that provides flowing marking without requirement for substantial pressure application; and
providing holding foam surround for a user to gently pince the assistive marker by the forefinger and the thumb only partially away from the user's natural resting spacing forefinger and the thumb and thereby not require overextension of the fingers into a claw position;
wherein the user is led back onto a development path towards a dynamic tripod grasp.

18. An assistive marker which is an integral liquid ink-based marker pen for assisting users in their development of marking skills comprising:
a substantially cylindrical body
having a relative diametrical size and constant cross-sectional shape relative to the natural resting spacing of the V-section of the user's forefinger and the thumb to avoid overextension of the fingers of the user into a claw like hold but instead to encourage a relatively relaxed pincer/tripod grip, and
integrally including a marking liquid reservoir and connects to a protruding nib or stylus, wherein the nib or stylus is a wicking nib connected to the marking liquid reservoir for wicking therefrom, and
an outer holding surface including a ring of foam around the circumference of the substantially cylindrical body, allowing a low pressure holding without overextension;
wherein the assistive marker is sized and shaped to fit substantially within the natural resting spacing of the V-section of the user's forefinger and the thumb and to be spaced from the palm of the user,
and wherein the user is able to hold and use the assistive marker in a relatively forefinger and thumb.

19. An assistive marker according to claim 18, wherein the body has a diametrical size substantially in the range of 80 to 110% of the natural resting spacing of the user's forefinger and thumb wherein the cylindrical body has a diameter in the range of 25 to 35 millimetres and a length in the range of 20 to 40 millimetres.

20. An assistive marker according to claim 18 wherein the lid has a diameter smaller that the body of the assistive marker so that an infant's hand can readily grasp the lid in any circumferential orientation and the lid includes fluting around the circumference of the lid and the fluting is consistently spaced to enhance grippability.
